(19) United States
(12) Patent Application Publication
(10) Pub. No.: US 2014/0184493 A1
(43) Pub. Date: Jul. 3, 2014

(54) ELECTRONIC DEVICE AND GESTURE CONTOL METHOD FOR ELECTRONIC DEVICE

(71) Applicant: HON HAI PRECISION INDUSTRY CO., LTD., New Taipei (TW)

(72) Inventor: HONG-SHENG CHEN, New Taipei (TW)

(73) Assignee: HON HAI PRECISION INDUSTRY CO., LTD., New Taipei (TW)

(21) Appl. No.: 14/139,177

(22) Filed: Dec. 23, 2013

(30) Foreign Application Priority Data
Dec. 28, 2012 (TW) 101150866

(51) Int. Cl. G06F 3/01

(52) U.S. Cl. CPC G06F 3/017
USPC 345/156

(57) ABSTRACT

A control method is applied to an electronic device to control the electronic device by a user's gestures in real time. When the user's gestures change from a first predetermined gesture to a second predetermined gesture, the control method controls the electronic device to perform a corresponding function.

### BACKGROUND

1. Technical Field

The present disclosure relates to electronic devices, and particularly to an electronic device and a control method for controlling the electronic device by gestures.

2. Description of Related Art

Electronic devices, such as television devices, are controlled by remote controls. The remote control includes a number of buttons. In operation, a user must press a unique sequence of buttons to activate a corresponding function of the electronic device. As electronic devices get more and more functions, it becomes more and more troublesome to control the television by the remote control.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 shows an embodiment of functional blocks of an electronic device.

FIG. 2 shows relationships between gestures and preset commands in the electronic device of FIG. 1.

FIG. 3 shows a first state of a user interface provided by a gesture control system of the electronic device.

FIG. 4 shows a second state of the user interface of FIG. 3.

FIG. 5 shows a third state of the user interface of FIG. 3.

FIG. 6 shows a fourth state of the user interface of FIG. 3.

FIGS. 7-8 show an embodiment of a flowchart of a control method for controlling the electronic device of FIG. 1.

FIGS. 9-10 show an embodiment of a flowchart of a control method for adjusting a volume of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

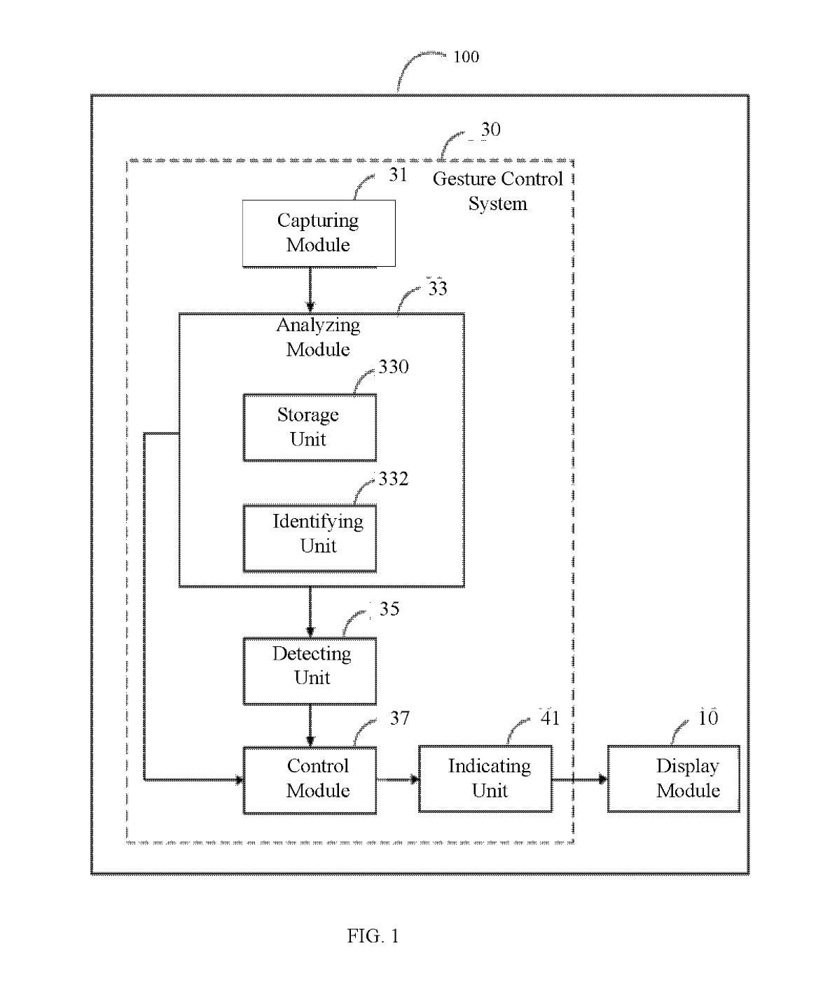

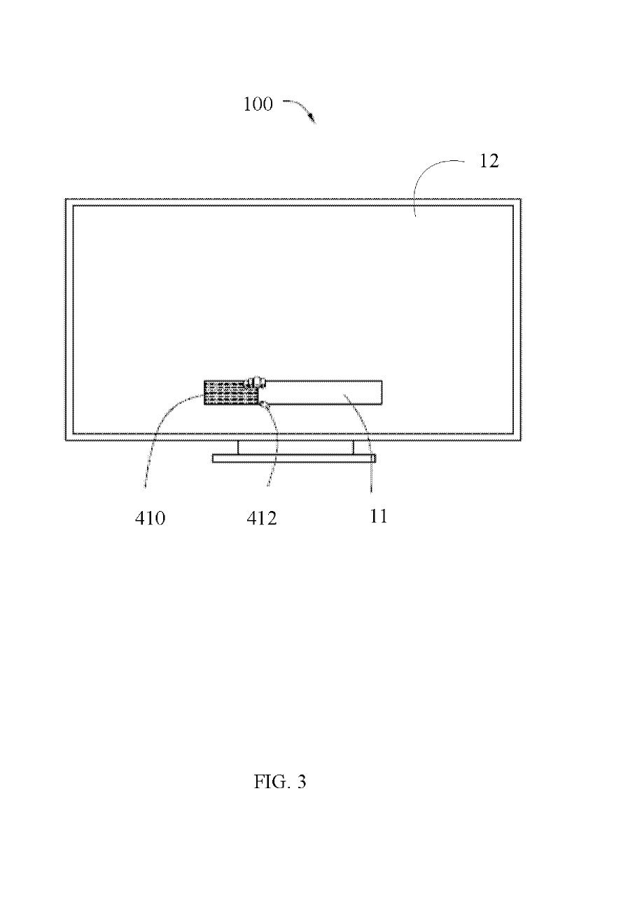

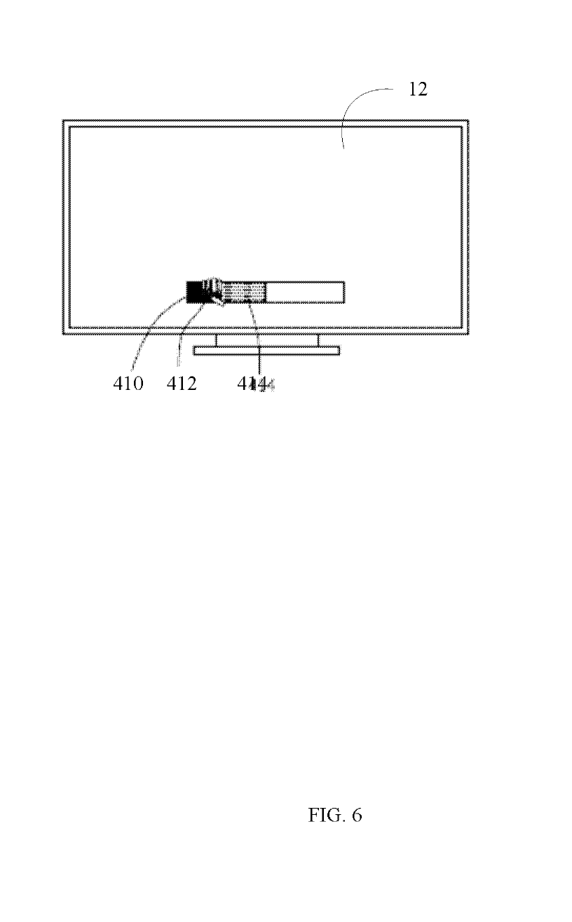

FIG. 1 shows an embodiment of function blocks of an electronic device 100. The electronic device 100 includes a display module 10, a gesture control system 30, and a number of applications (not shown) associated with a number of user interfaces, such as a user interface 12 (see FIGS. 3-6). The electronic device can be, but is not limited to, a television, a computer, or a mobile phone. The display module 10 can be an LED display or an LCD display, for example. The applications can be, but are not limited to, an audio setting application for adjusting a volume of the electronic device 100, a channel selection application for selecting a desired channel, or a display setting application for adjusting a chroma or brightness of a display. When one of the applications is activated, the activated application displays the corresponding user interface 12 on the display module 10.

The gesture control system 30 activates one of the applications and controls the activated application to execute corresponding functions according to a user's gestures. In one embodiment, the gesture control system 30 includes a capturing module 31, an analyzing module 33, a detecting module 35, a control module 37, and an indicating module 41.

The capturing module 31 is configured to obtain a user's gestures in real time. In one embodiment, the capturing module 31 is a camera, which captures images of the user's hand to obtain the gestures.

The analyzing module 33 is configured to identify whether the obtained gesture satisfies a predetermined condition, and generates a corresponding instruction to control the electronic device 100 to perform a corresponding function when the obtained gesture satisfies the predetermined condition. In one embodiment, the analyzing module 33 includes a storage unit 330 and an identifying unit 332.

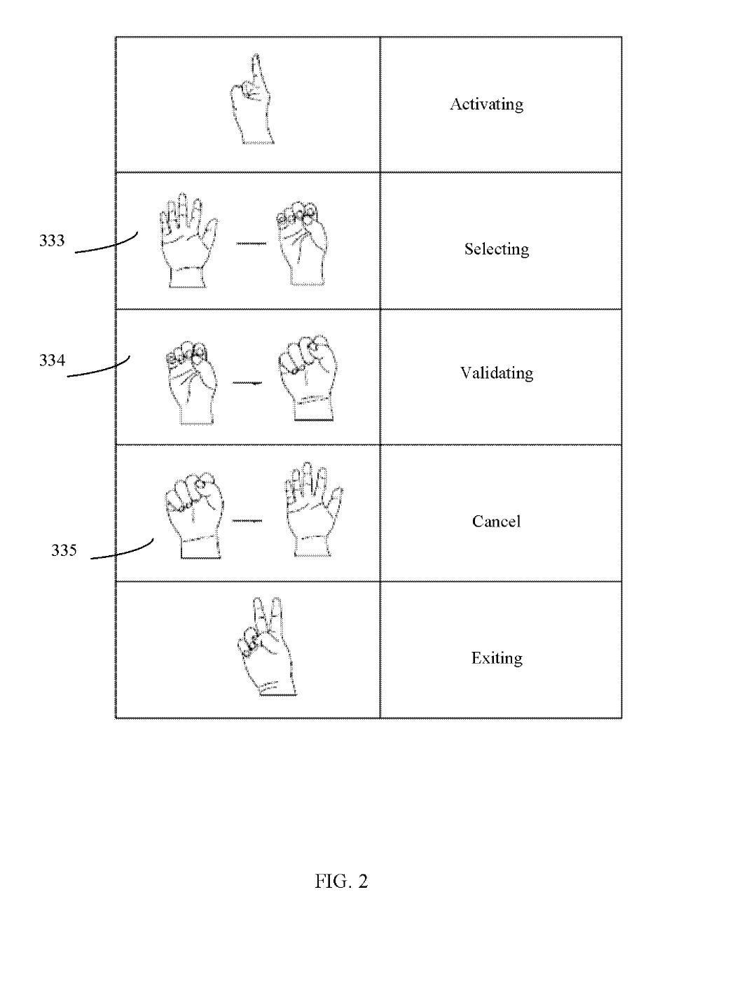

The storage unit 330 stores the predetermined condition. The predetermined condition includes a number of control gestures and a number of executing gestures. In one embodiment, each control gesture is a static gesture, such as holding up one finger or two fingers, and each executing gesture is a dynamic gesture. In one embodiment, the control gestures include an activating gesture and an exiting gesture (see FIG. 2). The activating gesture is used to activate one of the applications, such that the application displays the corresponding user interface 12. In one embodiment, each application is activated by a different activating gesture. For example, a gesture of holding up one finger activates the audio setting application, and a gesture of holding up three fingers activates the channel selection application. The exiting gesture controls the activated application to exit. In one embodiment, the exiting gesture for all the applications is the same, such as a gesture of holding up two fingers.

In the illustrated embodiment, each executing gesture is dynamic and includes a set of moving gestures, such as changing a hand position from a predetermined initial gesture to a predetermined final gesture In one embodiment, the executing gestures include a selecting gesture 333, a validating gesture 334, and a canceling gesture 335 (see FIG. 2) The selecting gesture 333 is configured to select one function of the executed application. For example, the selecting gesture 333 is changing the hand position from an open palm to a half fist, according to the predetermined condition. The validating gesture 334 is configured to control the executed application to execute the selected function. For example, the validating gesture 334 is changing the hand position from the half fist to a closed fist, according to the predetermined condition. The canceled gesture 335 is configured to cancel the selected function. For example, the canceling gesture is changing the hand position from the closed fist to the open palm, according to the predetermined condition. In other words, in this embodiment, the predetermined original gesture of the selecting gesture 333 is an open palm, and the predetermined final gesture of the selecting gesture 333 is a half fist. The predetermined original gesture of the selecting gesture 333 is half fist, and the predetermined final gesture of the validating gesture 334 is a closed fist. The predetermined original gesture of the cancel gesture 335 is closed fist, and the predetermined final gesture of the validating gesture 333 is an open palm.

The identifying unit 332 is configured to identify whether the obtained gestures satisfy the predetermined condition by comparing the obtained gesture with the predetermined gestures stored in the storage unit 330, and generate a corresponding control instruction to enable the control module 37 to activate the corresponding application or control the activated application to execute corresponding functions. For example, when the obtained gesture matches the activating gesture or the exiting gesture, the identifying unit 332 generates an activate instruction to activate the corresponding application according to the activating gesture, or generates an exit instruction to control the activated application to exit according to the exiting gesture. When the obtained gesture matches an executing gesture, the identifying unit 332 generates an execute instruction to control the activated application to perform the corresponding function.

In one embodiment, the detecting unit 35 is configured to detect a manner of movement of the selecting gesture for adjusting a parameter indicated by the adjustment bar 11. For example, when the executed application is the volume setting application, the selecting gesture is move left or right, the detecting unit 35 generates an indicating instruction according to the manner of movement of the selecting gesture for adjusting the volume.

Referring to FIGS. 3-6, the indicating unit 41 displays a cursor 412 on an adjustment bar 11 in the user interface 12 according to the selecting instruction, and shifts the cursor 412 according to the indicating instruction. In one embodiment, the adjustment bar 11 presents a first symbol 410 from a start of the adjustment bar 11 to the cursor 412 to indicate a value of a corresponding parameter of the adjustment bar 11. The cursor 412 is shifted according to the indicating instruction, and the adjustment bar 11 presents a second symbol 414 to indicate a movement of the cursor 412. For example, when the cursor 412 is moved to the start of the adjustment bar 11, the second symbol 414 covers the first symbol 410. When the cursor 412 is moved away from the start of the adjustment bar 11, the second symbol 414 extends from an end of the first symbol 410 toward an end of the adjustment bar 11 away from the start of the adjustment bar 11. In one embodiment, the adjustment bar 11 is a white strip bar, the first symbol 410 is a black bar, and the second symbol 414 is a bar filled with dots.

As an example, the volume of the electronic device 100 is pre-set as 50 decibels (dB) to describe how to manipulate the electronic device 100 by the gestures.

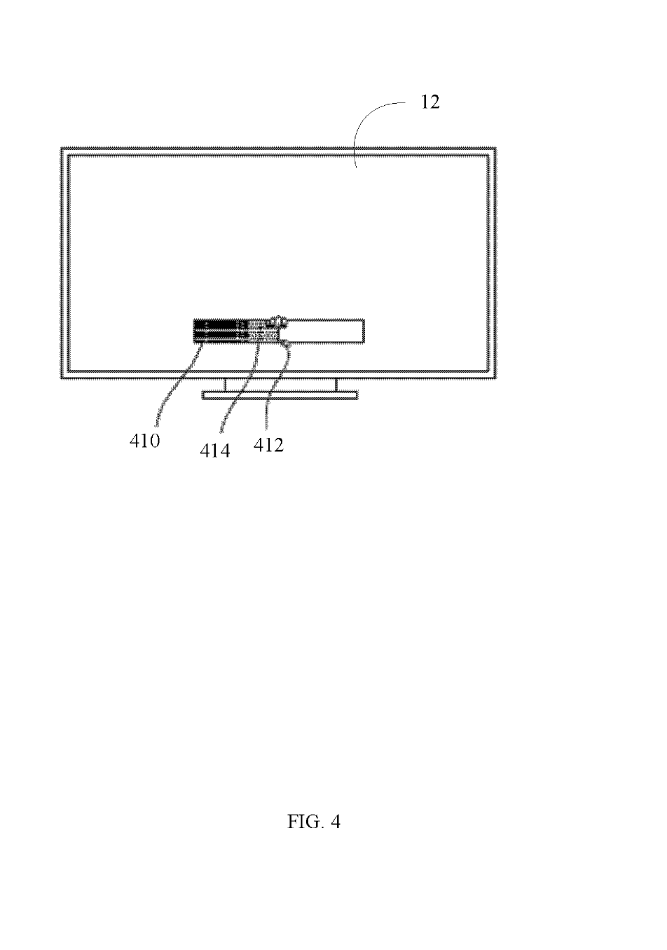

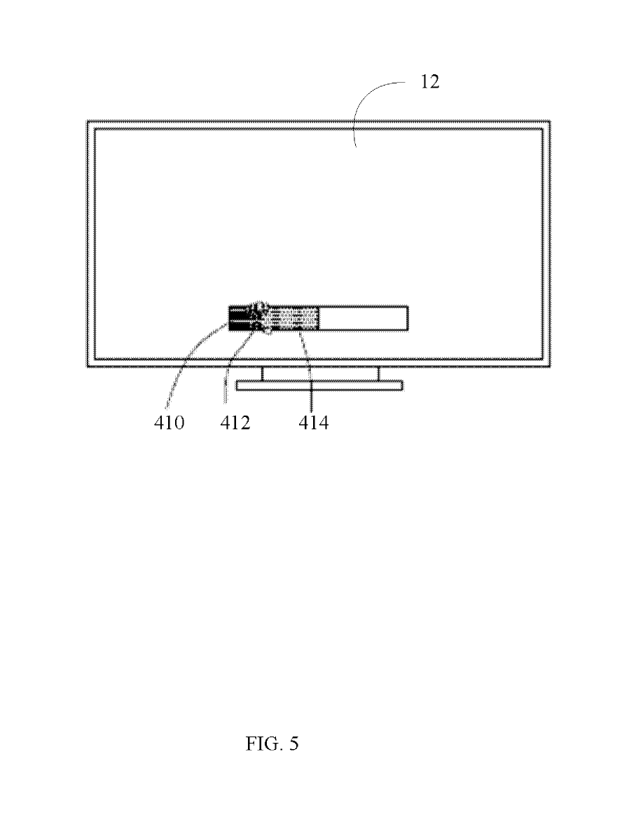

In operation, when the user holds up one finger, the capturing module 31 obtains the gesture, and the analyzing module 33 determines that the obtained gesture is the activating gesture for the audio setting application. The analyzing module 33 generates the activate instruction to activate the audio setting application and display the corresponding user interface 12 on the display module 10. When the user makes the selecting gesture, the capturing module 31 obtains the gesture, and the analyzing module 33 determines that the obtained gesture is the selecting gesture. The analyzing module 33 generates the selecting instruction to control the audio setting application to display the volume adjustment bar 11, such that the cursor 412 indicates 50 dB, and the first symbol 410 covers the adjustment bar 11 from the start of the adjustment bar 11, indicating 0 dB, to the cursor 412 (see FIG. 3). When the user maintains the half fist gesture and moves the half fist to the right, the detecting unit 35 detects that the half fist moves to the right, and generates the indicating instruction to control the cursor 412 to move toward the end of the adjustment bar 11 away from the start of the adjustment bar 11, and the second symbol 414 is presented and extends from the end of the first symbol 410 toward the end of the adjustment bar 11 (see FIG. 4). When the user maintains the half fist gesture and moves the half fist to the left, the detecting unit 35 detects that the half fist moves to the left, and generates the indicating instruction to control the cursor 412 to move toward the start of the adjustment bar 11, such that the cursor 412 moves toward the start of the adjustment bar 11, and the second symbol 414 covers a portion of the first symbol 410 (see FIG. 5). When the user changes the half fist gesture to the closed fist gesture, the capturing module 31 obtains the closed fist gesture, and the analyzing module 33 determines that the obtained gesture is the validating gesture. The analyzing module 33 generates the validate instruction to control the audio setting application to adjust the volume of the electronic device 100 to a level according to the indication of the cursor 412. If the user makes the cancel gesture, the analyzing module 33 generates the cancel instruction to control the audio setting application to maintain the original volume of the electronic device 100 if the cursor 412 has already been moved.

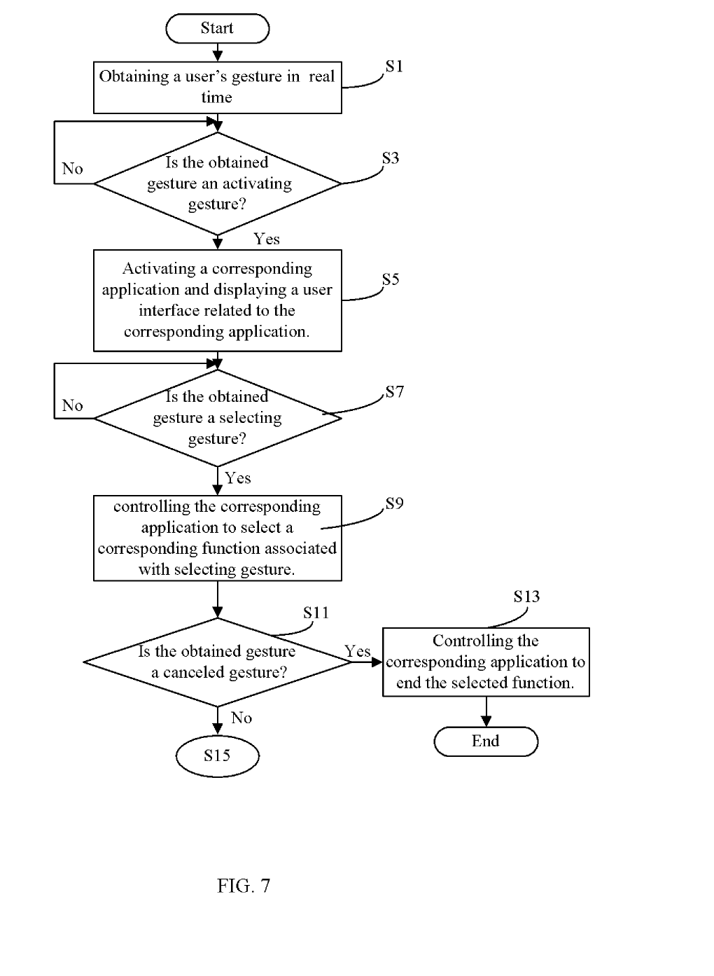

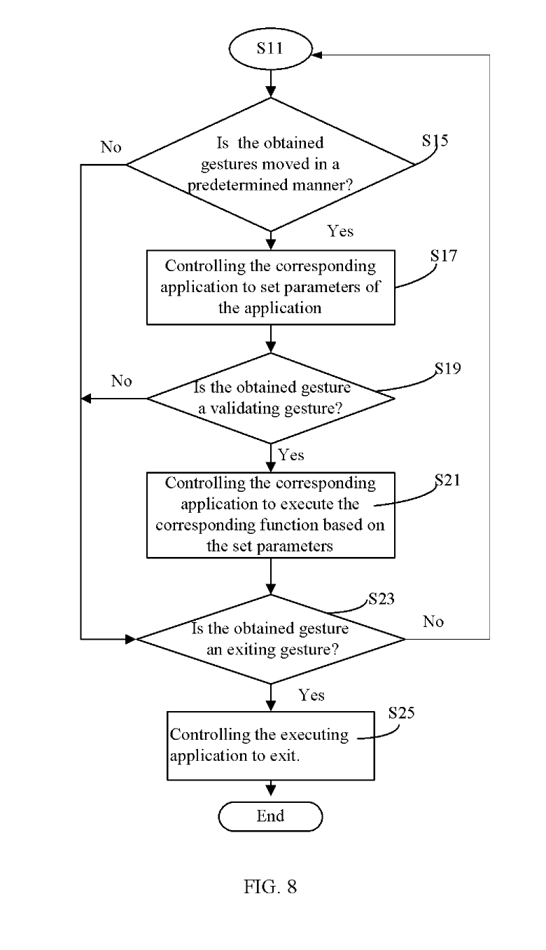

FIGS. 7 and 8 show a flowchart of a control method for the electronic device 100. The control method includes the following steps.

Step S1 is obtaining a user's gesture in real time by capturing an image of a hand of the user.

Step S3 is analyzing whether the obtained gesture is an activating gesture for a corresponding application of the electronic device 100. If the obtained gesture is the activating gesture, the process goes to step S5. Otherwise, step S3 is repeated.

Step S5 is activating the corresponding application and displaying a user interface of the corresponding application.

Step S7 is obtaining the user's gesture in real time to determine whether the obtained gesture is a selecting gesture associated with a corresponding function of the corresponding application. If the obtained gesture is the selecting gesture, the process goes to step S9. Otherwise, step S7 is repeated.

Step S9 is controlling the corresponding application to execute a corresponding function associated with a direction of movement of the selecting gesture.

Step S11 is determining whether the obtained gesture is a canceling gesture. If the obtained gesture is the canceling gesture, the process goes to step S13. Otherwise, the process goes to step S15.

Step S13 is controlling the corresponding application to maintain an original parameter of the corresponding application.

Step S15 is detecting whether the obtained gesture is moved in a predetermined manner, such as move left or right. If the obtained gesture is moved in the predetermined manner, the process goes to step S17. Otherwise, the process goes to step S23.

Step S17 is controlling the corresponding application to adjust a parameter of the corresponding application according to the movement of the gesture, such as increasing or decreasing the volume level.

Step S19 is determining whether the obtained gesture is a validating gesture. If the obtained gesture is the validating gesture, the process goes to step S21. Otherwise, the process goes to step S23.

Step S21 is controlling the corresponding application to execute the corresponding function based on the corresponding set parameter, such as adjusting the volume of the electronic device 100 to the set volume level.

Step S23 is determining whether the obtained gesture is an exiting gesture for the executed application. If the obtained gesture is the exiting gesture, the process goes to step S25. Otherwise, the process goes to step S11.

Step S25 is controlling the executing application to exit.

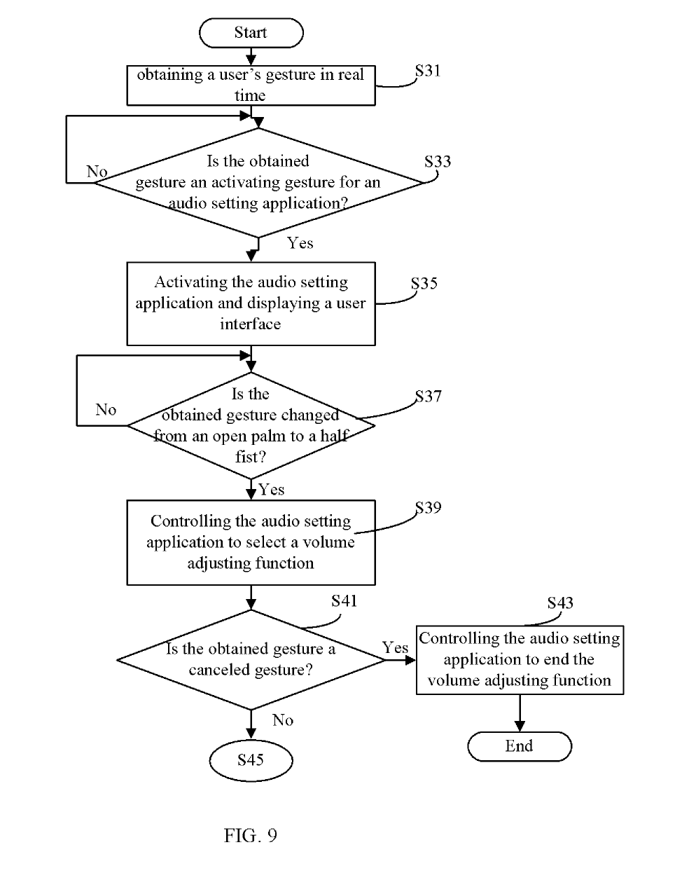

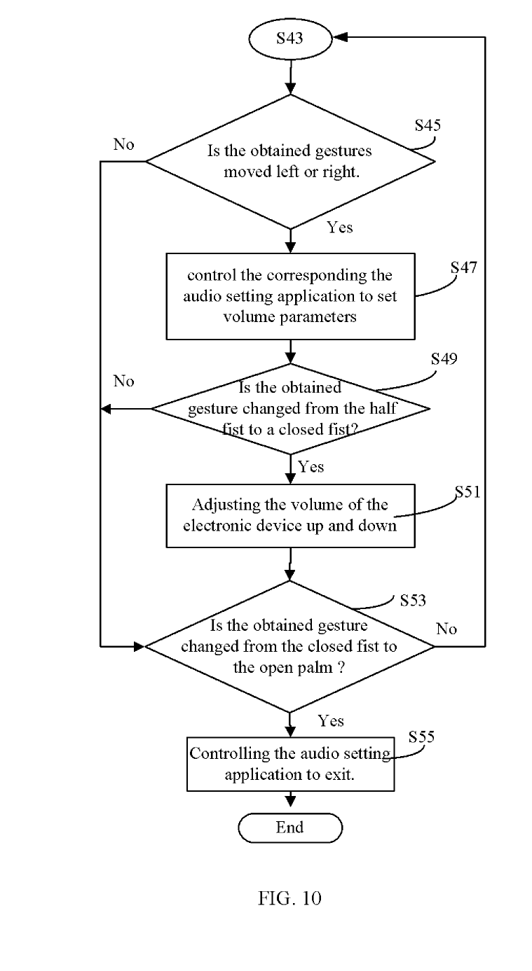

FIGS. 9 and 10 show a flowchart of a control method for adjusting the volume of an electronic device by gestures. The control method includes the following steps.

Step S31 is obtaining a gesture of a user in real time. In detail, the gesture is obtained by capturing an image of a hand of the user.

Step S33 is analyzing whether the obtained gesture is an activating gesture for an audio setting application of the electronic device. When the obtained gesture is the activating gesture, the process goes to step S35, otherwise, step S33 is repeated.

Step S35 is activating the audio setting application and displaying a user interface related to the audio setting application.

Step S37 is determining whether the obtained gesture is a selecting gesture which changed from an open palm to a half fist according to a predetermined condition. When the obtained gestures is changed from the open palm to the half fist according to the predetermined condition, the processes goes to step S39, otherwise step S37 is repeated.

Step S39 is controlling the audio setting application to select a volume adjusting function for adjusting the volume level of the electronic device associated with the selecting gesture.

Step S41 is determining whether the obtained gesture is a canceled gesture which is changed from the half fist to the open palm. When the obtained gesture is the canceled gesture, the process goes to step S43, otherwise the process goes to step S45.

Step S43 is controlling the audio setting application to end the volume adjusting function.

Step S45 is detecting whether the obtained gestures is moved left or right. When the obtained gesture is moved left or right, the process goes to step S47, otherwise the process goes to S53.

Step S47 is controlling the corresponding the audio setting application to set volume parameters of the application.

Step S49 is determining whether the obtained gesture is a validating gesture which is changed from the half fist to the closed fist. When the obtained gesture is a validating gesture, the process goes to step S51, otherwise the process goes to step S53.

Step S51 is controlling the corresponding application to execute the corresponding function based on the set parameters, such as adjusting the volume of the electronic device to the set volume level.

Step S53 is determining whether the obtained gesture is an exiting gesture for the audio setting application. When the obtained gesture is the exiting gesture, the process goes to step S55, otherwise the process goes to step S43.

Step S55 is controlling the audio setting application to exit.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A control system applied to an electronic device for manipulating the electronic device, the electronic device comprising a plurality of applications to execute corresponding functions, the control system comprising:
a capturing module to obtain a user's gesture in real time;
an analyzing module to determine whether the obtained gesture satisfy a predetermined condition that changes from a first predetermined gesture to a second predetermined gesture different from the first predetermined gesture, and generate a control instruction when the obtained gesture satisfies the predetermined condition; and
a control module to control the electronic device to perform a corresponding function in response to the control instruction.

2. The control system of claim 1, wherein the first predetermined gesture is an open palm, and the predetermined second gesture is a half fist, the control module controls the electronic device to set parameters of the electronic device in response to the control instruction.

3. The control system of claim 2, wherein the first predetermined gesture is a half fist, and the second predetermined gesture is a closed fist, the control module controls the electronic device to execute the corresponding function base on the set parameters.

4. The control system of claim 3, wherein the first predetermined gesture is a closed fist, and the second predetermined gesture is an open palm, the control module controls the set parameters invalidate.

5. The control system of claim 1, wherein the analyzing module is further configured to identifying whether the obtained gesture matches a predetermined activating gesture which is static, when the analyzing module determines that the obtained gesture matches the predetermined activating gesture, the analyzing module generates an activating instruction, the control module activates a corresponding application of the electronic device in response to the activating instruction.

6. The control system of claim 5, wherein the analyzing module is further configured to identify whether the obtained gesture matches a predetermined exiting gesture which is dynamic, the analyzing module further generates exiting instruction, the control module cancels the set parameters.

7. An electronic device, comprising:
a plurality of applications to be executed to call corresponding functions;
a camera to capture an image of user's gestures in real time;
an analyzing module to analyze the image to determine whether the user's gesture satisfies a predetermined condition that a first predetermined gesture is changed to a second predetermined gesture accordingly, and generates a control instruction when the user's gesture satisfies the predetermined condition; and
a control module to control the corresponding application to perform the associated function in response to the control instruction.

8. The electronic device of clam 7, wherein the electronic device further comprises a storage module to store the predetermined executing gestures.

9. The electronic device of claim 7, wherein the first predetermined gesture is an open palm, the predetermined second gesture is a half fist, the control module setting parameters for the associated function in response to the control instruction.

10. The electronic device of claim 7, wherein the first predetermined gesture is a half fist, the second predetermined gesture is a closed fist, the control module controls control the associated function to be execute based on the set parameters.

11. The electronic device of claim 7, wherein the first predetermined gesture is a fist, the second predetermined gesture is an open palm, the control module cancels the set parameters.

12. A control method, being applied to an electronic device to manipulate the electronic device respond to gestures, the control method comprising steps of:
obtaining a user's gestures in real time;
analyzing whether the obtained gestures match predetermined executing gestures when changing from a first predetermined gesture to a second predetermined gestures different from the first predetermined gestures according to predetermined condition; and
performing a corresponding function.

13. The control method of claim 12, wherein the first predetermined gesture is an open palm, the predetermined second gesture is a half fist, the performed function is to set parameters of the electronic device

14. The control method of claim 12, wherein the first predetermined gesture is a half fist, the second predetermined gesture is a closed fist, the performed function is to execute the function based on the set parameters.

15. The control method of claim 12 wherein the first predetermined gesture is a fist, the second predetermined gesture is an open palm, the performed function is to cancel the set parameters.

16. The control method of claim 12, wherein before analyzing whether the obtained gestures match predetermined executing gestures, the control method further comprises step of:
determining whether the obtained gesture matches a predetermined activating gesture which is static, and
analyzing whether the obtained gestures match predetermined executing gestures when the obtained gesture matches with a predetermined activating gesture.

17. The control method of claim 16, wherein after determining whether the obtained gesture matches a predetermined activating gesture, the control method further comprises step of:
determining where the obtained gesture matches a predetermined exiting gesture; and
ending the executed function.
